(19) United States
(12) Patent Application Publication
(10) Pub. No.: US 2023/0022925 A1
(43) Pub. Date: Jan. 26, 2023

(54) RUBBER COMPOSITION

(71) Applicant: COMPAGNIE GENERALE DES ETABLISSEMENTS MICHELIN, Clermont-Ferrand (FR)

(72) Inventors: FREDERIC LEMERLE, Clermont-Ferrand (FR); BENOIT CEREDE, Clermont-Ferrand (FR); JOSE-CARLOS ARAUJO-DA-SILVA, Clermont-Ferrand (FR)

(21) Appl. No.: 17/786,317

(22) PCT Filed: Dec. 9, 2020
(86) PCT No.: PCT/FR2020/052352

§ 371 Date: Jun. 16, 2022

(30) Foreign Application Priority Data
Dec. 16, 2019 (FR) FR1914471

(51) Int. Cl. C08L 7/00; B60C 1/00; B60C 13/00

(52) U.S. Cl. CPC C08L 7/00; B60C 1/0025; B60C 13/00; B60C 2013/006; C08L 2205/03

(57) ABSTRACT

A rubber composition, which exhibits an improved fatigue strength and stiffness performance compromise, is based on at least one elastomer matrix containing at least one polyisoprene and at least one copolymer containing ethylene units and diene units; a paraffin oil having a glass transition temperature of less than -75° C.; a reinforcing filler comprising carbon black; and a crosslinking system, in which the at least one polyisoprene and the at least one copolymer containing ethylene units and diene units represent more than 40% by weight of the elastomer matrix.

The field of the present invention is that of rubber compositions reinforced with carbon black and comprising a highly saturated diene elastomer, the rubber compositions being particularly intended for use in a tyre, more particularly in a tyre sidewall.

A tyre usually comprises two beads intended to come into contact with a rim, a crown composed of at least one crown reinforcement and a tread, and two sidewalls, the tyre being reinforced by a carcass reinforcement anchored in the two beads. A sidewall is an elastomeric layer positioned outside the carcass reinforcement relative to the internal cavity of the tyre, between the crown and the bead, so as to completely or partially cover the region of the carcass reinforcement extending from the crown to the bead.

In the conventional manufacture of a tyre, the various constituent components of the crown, of the carcass reinforcement, of the beads and of the sidewalls are assembled to form a pneumatic tyre. The assembly step is followed by a step of forming the tyre so as to give the assembly the toric shape before the in-press curing step.

Tyres, and in particular the sidewalls, are subjected to numerous mechanical stresses which are repeated cyclically during running. These stresses, in the form of bending and compressive stresses, test the endurance of the tyre and contribute to reducing its lifetime. One way to improve the endurance of the tyre lies in increasing the fatigue resistance of the rubber compositions which constitute the tyre. For example, the use of silica with a low specific surface area typically less than 125 m²/g, even much less than 100 m²/g, in a rubber composition is described respectively in patents EP 722 977 B1 and EP 547 344 B1 as being favourable to fatigue resistance.

Furthermore, tyre sidewalls are also exposed to the action of ozone. The deformation cycles combined with the action of ozone can cause cracks or fissures to appear in the sidewall, preventing the use of the tyre regardless of the wear of the tread. Consequently, rubber compositions are sought which are very cohesive in order to constitute, for example, tyre sidewalls by virtue of their capacity to undergo large deformations without breaking, even in the presence of a crack initiation.

To minimize the action of ozone on rubber compositions, it is known to use copolymers exhibiting less sensitivity to oxidation, such as, for example, highly saturated diene elastomers, elastomers comprising ethylene units at a molar content of greater than 50 mol% of the monomer units of the elastomer. Mention may be made, for example, of copolymers of ethylene and of 1,3-diene which contain more than 50 mol% of ethylene, in particular copolymers of ethylene and of 1,3-butadiene. The use of such copolymers of ethylene and of 1,3-butadiene in a tread of a tyre is for example described in document WO 2014/114607 A1 and has the effect of conferring on the tyre good wear resistance and rolling resistance properties. The use of copolymers of ethylene and of 1,3-diene in a composition for sidewalls is also, for example, described in document EP 2 682 423 A1 for increasing resistance to ozone. However, it remains advantageous to further improve the fatigue resistance, this being without degrading the other properties of the composition, in particular the stiffness and the rolling resistance.

Continuing its research, the applicant has discovered that the use of a specific plasticizer in a rubber composition comprising a highly saturated copolymer based on ethylene units and diene units makes it possible to improve the fatigue resistance of the rubber composition, without penalizing stiffness or even rolling resistance.

Thus, a first subject of the invention is a rubber composition based on at least:
an elastomer matrix containing at least one polyisoprene and at least one copolymer containing ethylene units and diene units,
a paraffin oil having a glass transition temperature, Tg, of less than -75° C.,
a reinforcing filler comprising carbon black, and
a crosslinking system,
in which the at least one polyisoprene and the at least one copolymer containing ethylene units and diene units represent more than 40% by weight of the elastomer matrix.

Another subject of the composition is a tyre comprising a composition according to the invention.

### I- DEFINITIONS

The expression "composition based on" should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

The expression "phr" should be understood as meaning, for the purposes of the present invention, the part by weight per hundred parts by weight of elastomer.

In the present document, unless expressly indicated otherwise, all the percentages (%) indicated are percentages (%) by weight.

Furthermore, any interval of values denoted by the expression "between a and b" represents the range of values extending from more than a to less than b (that is to say, limits a and b excluded), while any interval of values denoted by the expression "from a to b" means the range of values extending from a up to b (that is to say, including the strict limits a and b). In the present document, when an interval of values is denoted by the expression "from a to b", the interval represented by the expression "between a and b" is also and preferentially denoted.

In the present application, the expression "all of the monomer units of the elastomer" or "the total amount of the monomer units of the elastomer" means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the monomer units of the elastomer.

When reference is made to a "predominant" compound, this is understood to mean, for the purposes of the present invention, that this compound is predominant among the compounds of the same type in the composition, that is to say that it is that which represents the greatest amount by weight among the compounds of the same type. Thus, for example, a predominant elastomer is the elastomer representing the greatest weight relative to the total weight of the elastomers in the composition. In the same way, a "predominant" filler is that representing the greatest weight among the fillers of the composition. By way of example, in a system comprising just one elastomer, the latter is predominant for the purposes of the present invention and, in a system comprising two elastomers, the predominant elastomer represents more than half of the weight of the elastomers. On the contrary, a "minor" compound is a compound which does not represent the greatest fraction by weight among the compounds of the same type. Preferably, the term "predominant" is understood to mean present at more than 50%, preferably more than 60%, 70%, 80%, 90%, and more preferentially the "predominant" compound represents 100%.

The carbon-comprising compounds mentioned in the description can be of fossil or biobased origin. In the latter case, they can partially or completely result from biomass or be obtained from renewable starting materials resulting from biomass. Polymers, plasticizers, fillers, and the like, are concerned in particular.

All the values for glass transition temperature "Tg" described in the present document are measured in a known way by DSC (Differential Scanning Calorimetry) according to Standard ASTM D3418 (1999).

### II- DESCRIPTION OF THE INVENTION

### II-1 Elastomer Matrix

According to the invention, the elastomer matrix comprises more than 40% by weight of at least one polyisoprene and at least one copolymer containing ethylene units and diene units (hereinafter referred to as "the copolymer").

The term "elastomer matrix" is intended to mean all the elastomers of the composition.

The term "copolymer containing ethylene units and diene units" is intended to mean any copolymer comprising, within its structure, at least ethylene units and diene units. The copolymer can thus comprise monomer units other than ethylene units and diene units. For example, the copolymer can also comprise alpha-olefin units, in particular alpha-olefin units having from 3 to 18 carbon atoms, advantageously having 3 to 6 carbon atoms. For example, the alpha-olefin units can be selected from the group consisting of propylene, butene, pentene, hexene or mixtures thereof.

In a known way, the expression "ethylene unit" refers to the —(CH₂—CH₂)— unit resulting from the insertion of ethylene into the elastomer chain.

The term "diene unit" is intended to mean a monomer unit originating from the insertion of a monomer subunit resulting from the polymerization of a conjugated diene monomer or of a non-conjugated diene monomer, the diene unit comprising a carbon-carbon double bond. Preferably, the diene units are selected from the group consisting of butadiene units, isoprene units and mixtures of these diene units. In particular, the diene units of the copolymer can be 1,3-diene units having 4 to 12 carbon atoms, for example 1,3-butadiene or 2-methyl-1,3-butadiene units. More preferably, the diene units are predominantly, or even preferentially exclusively, 1,3-butadiene units.

In the copolymer, the ethylene units advantageously represent between 50 mol% and 95 mol% of the monomer units of the copolymer, that is to say between 50 mol% and 95 mol% of the monomer units of the copolymer. Advantageously, the ethylene units in the copolymer represent more than 60 mol%, preferably more than 70 mol% of the monomer units of the copolymer. Also advantageously, in the copolymer, the ethylene units represent at most 90 mol%, preferably at most 85 mol%, of the monomer units of the copolymer.

Advantageously, the copolymer (that is to say, as a reminder, the at least one copolymer containing ethylene units and diene units) is a copolymer of ethylene and of 1,3-diene (preferably 1,3-butadiene), that is to say, according to the invention, a copolymer consisting exclusively of ethylene units and of 1,3-diene (preferably 1,3-butadiene) units, more preferentially a random copolymer of ethylene and of 1,3-diene (preferably 1,3-butadiene).

When the copolymer is a copolymer of ethylene and of a 1,3-diene, said copolymer advantageously contains units of formula (I) and/or (II). The presence of a saturated 6-membered cyclic unit, 1,2-cyclohexanediyl, of formula (I) as a monomer unit in the copolymer can result from a series of very particular insertions of ethylene and of 1,3-butadiene in the polymer chain during its growth.

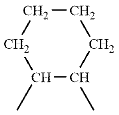

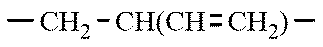

For example, the copolymer of ethylene and of a 1,3-diene can be devoid of units of formula (I). In this case, it preferably contains units of formula (II).

When the copolymer of ethylene and of a 1,3-diene comprises units of formula (I) or units of formula (II) or else units of formula (I) and units of formula (II), the molar percentages of units of formula (I) and of units of formula (II) in the highly saturated diene elastomer, respectively o and p, preferably satisfy the following equation (eq. 1), more preferentially satisfy the equation (eq. 2), o and p being calculated on the basis of all the monomer units of the highly saturated diene elastomer.

$$0 < \text{o+p} \leq \text{25}$$

$$0 < \text{o+p} \text{<} \text{20}$$

According to the invention, the copolymer, preferably the copolymer of ethylene and of a 1,3-diene (preferably of 1,3-butadiene), is a random copolymer.

Advantageously, the number-average weight (Mn) of the copolymer, preferably of the copolymer of ethylene and of a 1,3-diene (preferably of 1,3-butadiene), is within a range extending from 100 000 to 300 000 g/mol, preferably from 150 000 to 250 000 g/mol.

The Mn of the copolymer is determined in a known manner, by size exclusion chromatography (SEC) as described below:

The SEC (Size Exclusion Chromatography) technique makes it possible to separate macromolecules in solution according to their size through columns filled with a porous gel. The macromolecules are separated according to their hydrodynamic volume, the bulkiest being eluted first. Without being an absolute method, SEC makes it possible to comprehend the molar mass distribution of a polymer. The various number-average molar masses (Mn) and weight-average molar masses (Mw) can be determined from commercial standards and the polydispersity index (PI = Mw/Mn) can be calculated via a "Moore" calibration. There is no specific treatment of the polymer sample before analysis. The latter is simply dissolved in the elution solvent at a concentration of approximately 1 g.l⁻¹. The solution is then filtered through a filter with a porosity of 0.45 µm before injection. The apparatus used is a Waters Acquity or Waters Alliance chromatographic line. The elution solvent is tetrahydrofuran with 250 ppm of BHT (butylated hydroxytoluene) antioxidant, the flow rate is 1 ml.min⁻¹, the temperature of the columns is 35° C. and the analysis time is 40 min. The columns used are a set of three Agilent columns having the trade name InfinityLab PolyPore. The volume of the solution of the sample injected is 100 µl. The detector is an Acquity or Waters 2410 differential refractometer and the software for making use of the chromatographic data is the Waters Empower system. The calculated average molar masses are relative to a calibration curve produced with polystyrene standard.

The copolymer can be obtained according to various synthesis methods known to those skilled in the art, notably as a function of the targeted microstructure of the highly saturated diene elastomer. Generally, it can be prepared by copolymerization at least of a diene, preferably of a 1,3-diene, more preferably 1,3-butadiene, and of ethylene and according to known synthesis methods, in particular in the presence of a catalytic system comprising a metallocene complex. Mention may be made in this respect of catalytic systems based on metallocene complexes, which catalytic systems are described in documents EP 1 092 731, WO 2004035639, WO 2007054223 and WO 2007054224 in the name of the applicant. The copolymer, including the case when it is random, may also be prepared via a process using a catalytic system of preformed type such as those described in documents WO 2017093654 A1, WO 2018020122 A1 and WO 2018020123 A1.

The copolymer may consist of a mixture of copolymers containing ethylene units and diene units which differ from each other by virtue of their microstructures and/or their macrostructures.

As indicated above, the elastomer matrix of the composition according to the invention also contains a polyisoprene. The polyisoprene can be an elastomer of any microstructure.

Advantageously, the polyisoprene, preferably having a content by weight of 1,4-cis bonds of at least 90% of the weight of the polyisoprene, is a natural rubber, a synthetic polyisoprene or a mixture thereof. More preferably, the polyisoprene, preferably having a content by weight of cis-1,4 bonds of at least 90% of the weight of the polyisoprene, is a natural rubber.

The content of the copolymer, preferably the copolymer of ethylene and of 1,3-diene (preferably 1,3-butadiene), in the composition, may be less than 50 phr, preferably within a range extending from 15 to less than 45 phr, more preferably within a range extending from 20 to 40 phr.

Moreover, the content of polyisoprene, preferably of natural rubber, in the composition may be greater than 50 phr, preferably, within a range extending from more than 55 phr to 80 phr, more preferably within a range extending from 60 to 80 phr.

According to the invention, the elastomer matrix can comprise at least one other elastomer, which is not a polyisoprene or a copolymer containing ethylene units and diene units, but this is not necessary. Thus, preferentially, the at least one polyisoprene and at least one copolymer containing ethylene units and diene units represent more than 50%, preferably more than 60%, preferably more than 70%, preferably more than 80%, preferably more than 90% by weight of the elastomer matrix. Advantageously, the at least one polyisoprene and at least one copolymer containing ethylene units and diene units are the only elastomers of the composition, that is to say that they represent 100% by weight of the elastomer matrix.

When the elastomer matrix comprises at least one other elastomer, which is not a polyisoprene or a copolymer containing ethylene units and diene units, the at least one other elastomer can represent less than 50%, preferably less than 40%, preferably less than 30%, preferably less than 20%, preferably less than 10%, by weight of the elastomer matrix. The other elastomer can be any diene elastomer well known to those skilled in the art which is not a polyisoprene or a copolymer containing ethylene units and diene units.

### II-2 Liquid Plasticizer

According to the invention, the rubber composition is based on at least paraffin oil having a glass transition temperature (Tg) of less than -75° C.

The paraffin oil can be any paraffin oil well known to those skilled in the art, but provided that this oil has a Tg of less than -75° C. It can also be a mixture of several paraffin oils having a Tg less than -75° C.

Paraffin oils are plasticizers that are liquid at 20° C., called "low Tg plasticizers", known for their plasticizing properties with respect to elastomers. At ambient temperature (20° C.), low Tg plasticizers, which are more or less viscous, are liquids (that is to say, as a reminder, substances which have the ability to eventually assume the shape of their container), unlike in particular high Tg hydrocarbon resins, which are by nature solid at ambient temperature. Paraffin "oils" should also not be confused with paraffin "waxes" which are not liquid at ambient temperatures.

Advantageously, the Tg of the paraffin oil is within a range extending from -78° C. to -150° C., preferably from -80° C. to -120° C.

Furthermore, the paraffin oil that can be used according to the invention can be defined according to its degree of crystallinity. Advantageously, the paraffin oil has a degree of crystallinity of less than 20%, preferably less than 10%, more preferably less than 5%, measured by differential scanning calorimetry for a temperature of 20° C.

Standard ISO 1-1357-3 (2013) is used to determine the temperature and enthalpy of fusion and of crystallization of the polymers used by differential scanning calorimetry (DSC). The reference enthalpy of polyethylene is 277.1 J/g (according to Handbook of Polymer, 4th Edition, J. Brandrup, E. H. Immergut and E. A. Grulke, 1999).

For the purposes of the invention, the content of paraffin oil is within a range extending from 5 to 60 phr, preferably from 10 to 45 phr.

As examples of commercially available paraffin oils having a Tg of less than -75° C., mention may be made of the Extensoil51 oils from the company Repsol or the Tudalen 1968 oils from the company Hansen & Rosenthal.

The composition according to the invention may comprise a plasticizer that is liquid at 20° C. other than the paraffin oil having a Tg of less than -75° C. (referred to hereinafter as "other liquid plasticizer"), but this is neither mandatory, nor preferred.

Preferably, the total content of plasticizer that is liquid at 20° C., in the composition, is within a range extending from 5 to 60 phr, preferably from 10 to 45 phr.

In addition, the composition according to the invention advantageously does not comprise any plasticizer that is liquid at 20° C. other than the paraffin oil, or contains less than 15 phr thereof, preferably less than 10 phr thereof, preferably less than 5 phr thereof.

Particularly preferably, the paraffin oil having a Tg of less than -75° C. is the only plasticizer, of the composition according to the invention, that is liquid at 20° C.

### II-3 Reinforcing Filler

The rubber composition in accordance with the invention also has the essential characteristic of comprising a reinforcing filler comprising carbon black.

The rubber composition can comprise any other type of "reinforcing" filler known for its abilities to reinforce a rubber composition that can be used for the manufacture of tyres, for example an organic filler other than carbon black, a reinforcing inorganic filler, such as silica, with which a coupling agent is combined in a known manner. Such a reinforcing filler typically consists of nanoparticles, the (weight-)average size of which is less than a micrometre, generally less than 500 nm, most often between 20 and 200 nm, in particular and more preferentially between 20 and 150 nm.

The content of reinforcing filler is adjusted by those skilled in the art according to the use of the rubber composition. Advantageously, the content of reinforcing filler in the composition according to the invention is within a range extending from 20 to 80 phr, preferably from 25 phr to 65 phr, preferably from 25 to 49 phr.

All carbon blacks, in particular the blacks conventionally used in tyres or their treads, are suitable as carbon blacks. Among the latter, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as available commercially, or in any other form, for example as support for some of the rubber additives used. The carbon blacks might, for example, be already incorporated in the diene elastomer, in particular isoprene elastomer, in the form of a masterbatch (see, for example, applications WO97/36724-A2 and WO99/16600-A1).

Advantageously, the carbon black has a BET specific surface area within a range extending from 30 to 100 m²/g, preferably from 33 to 70 m²/g, more preferably from 35 to 50 m²/g. The BET specific surface area can be measured according to Standard ASTM D6556-09 [multipoint method (5 points) - gas: nitrogen - relative pressure range P/P0: 0.05 to 0.30].

Advantageously, the reinforcing filler predominantly, preferably exclusively, comprises carbon black. In particular, the reinforcing filler preferably consists of at least 80% by weight, preferably at least 90% by weight, of carbon black. Particularly preferably, the reinforcing filler comprises exclusively, that is to say 100% by weight, carbon black.

The content of carbon black, in the composition according to the invention, is preferentially within a range extending from 20 to 80 phr, preferably from 25 phr to 65 phr and preferably from 25 to 49 phr. The carbon black may be a mixture of various carbon blacks, in which case the contents of carbon black relate to all the carbon blacks.

When a reinforcing inorganic filler is used, it may be the case in particular of mineral fillers of the siliceous type, preferentially silica (SiO₂), or of the aluminous type, especially alumina (Al₂O₃). The silica used can be any reinforcing silica known to those skilled in the art, in particular any precipitated or fumed silica exhibiting a BET specific surface area and a CTAB specific surface area both of less than 450 m²/g, preferably within a range extending from 30 to 400 m²/g, in particular from 60 to 300 m²/g.

In the present disclosure, the BET specific surface area is determined by gas adsorption using the Brunauer-Emmett-Teller method described in "The Journal of the American Chemical Society", (Vol. 60, page 309, February 1938), and more specifically according to a method derived from Standard NF ISO 5794-1, appendix E, of June 2010 [multipoint (5 point) volumetric method - gas: nitrogen - degassing under vacuum: one hour at 160° C. - relative pressure p/po range: 0.05 to 0.17].

For the inorganic fillers, such as silica, for example, the CTAB specific surface area values were determined according to Standard NF ISO 5794-1, Appendix G, of June 2010. The process is based on the adsorption of CTAB (N-hexadecyl-N,N,N-trimethylammonium bromide) on the "external" surface of the reinforcing filler.

The term "reinforcing inorganic filler" should be understood here as meaning any inorganic or mineral filler, whatever its colour and its origin (natural or synthetic), also known as "white filler", "clear filler" or even "non-black filler", in contrast to carbon black, capable of reinforcing, by itself alone, without means other than an intermediate coupling agent, a rubber composition intended for the manufacture of tyres. In a known way, some reinforcing inorganic fillers can be characterized in particular by the presence of hydroxyl (-OH) groups at their surface.

Any type of precipitated silica, in particular highly dispersible precipitated silicas (referred to as "HDS" for "highly dispersible" or "highly dispersible silica"), can be used. These precipitated silicas, which are or are not highly dispersible, are well known to those skilled in the art. Mention may be made, for example, of the silicas described in applications WO03/016215-A1 and WO03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The reinforcing inorganic filler can be a mixture of various reinforcing inorganic fillers, in which case the proportions of reinforcing inorganic filler in the reinforcing filler relate to all of the reinforcing inorganic fillers.

Use may be made, in order to couple the reinforcing inorganic filler to the diene elastomer, in a well-known way, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term "bifunctional" is understood to mean a compound having a first functional group capable of interacting with the inorganic filler and a second functional group capable of interacting with the diene elastomer. For example, such a bifunctional compound can comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferably, the organosilanes are selected from the group consisting of organosilane polysulfides (symmetrical or asymmetrical), such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl)propyl) octanethioate sold by the company Momentive under the name NXT Silane. More preferentially, the organosilane is an organosilane polysulfide.

Of course, use might also be made of mixtures of the coupling agents described above.

When a reinforcing inorganic filler is used, the content of coupling agent in the composition of the invention can easily be adjusted by those skilled in the art. Typically, the content of coupling agent represents from 0.5% to 15% by weight, with respect to the amount of reinforcing inorganic filler.

### II-4 Crosslinking System

The crosslinking system can be any type of system known to those skilled in the art in the field of rubber compositions for tyres. It may in particular be based on sulfur, and/or on peroxide and/or on bismaleimides.

Preferentially, the crosslinking system is based on sulfur; it is then called a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or equivalent compound, such as stearic acid salts, and salts of transition metals, guanidine derivatives (in particular diphenylguanidine), or also known vulcanization retarders.

The sulfur is used at a preferential content of between 0.3 phr and 10 phr, more preferentially between 0.3 and 5 phr. The primary vulcanization accelerator is used at a preferential content of between 0.5 and 10 phr, more preferentially of between 0.5 and 5 phr.

Use may be made, as accelerator, of any compound capable of acting as accelerator of the vulcanization of diene elastomers in the presence of sulfur, in particular accelerators of the thiazole type, and also their derivatives, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to "MBTS"), N-cyclohexyl-2-benzothiazolesulfenamide ("CBS"), N,N-dicyclohexyl-2-benzothiazolesulfenamide ("DCBS"), N-(tert-butyl)-2-benzothiazolesulfenamide ("TBBS"), N-(tert-butyl)-2-benzothiazolesulfenimide ("TBSI"), tetrabenzylthiuram disulfide ("TBZTD"), zinc dibenzyldithiocarbamate ("ZBEC") and the mixtures of these compounds.

### II-5 Possible Additives

The rubber compositions according to the invention may optionally also comprise all or some of the usual additives customarily used in elastomer compositions for tyres, such as for example plasticizers (such as plasticizing oils and/or plasticizing resins), pigments, protective agents such as anti-ozone waxes, chemical anti-ozonants, antioxidants, anti-fatigue agents, reinforcing resins (as described for example in application WO 02/10269).

However, in a particularly advantageous manner, the composition according to the invention does not comprise any plasticizer other than those mentioned above, or comprises less than 20 phr thereof, preferably less than 10 phr thereof, preferably less than 5 phr thereof.

Advantageously, the composition according to the invention does not comprise any plasticizing hydrocarbon resin.

### II-6 Preparation of the Rubber Compositions

The compositions in accordance with the invention can be manufactured in appropriate mixers using two successive preparation phases well known to those skilled in the art:
a first phase of thermomechanical working or kneading ("non-productive" phase), that can be carried out in a single thermomechanical step during which all the necessary constituents, in particular the elastomeric matrix, the reinforcing filler and the optional other various additives, with the exception of the crosslinking system, are introduced into an appropriate mixer, such as a standard internal mixer (for example of 'Banbury' type). The incorporation of the optional filler into the elastomer can be carried out in one or more goes by thermomechanically kneading. In the case where the filler is already incorporated, in full or in part, in the elastomer in the form of a masterbatch, as is described, for example, in applications WO 97/36724 and WO 99/16600, it is the masterbatch which is directly kneaded and, if appropriate, the other elastomers or fillers present in the composition which are not in the masterbatch form, and also the optional other various additives other than the crosslinking system, are incorporated. The non-productive phase can be carried out at high temperature, up to a maximum temperature of between 110° C. and 200° C., preferably between 130° C. and 185° C., for a period of time generally of between 2 and 10 minutes;
a second phase of mechanical working ("productive" phase), which is carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

Such phases have been described, for example, in applications EP-A-0501227, EP-A-0735088, EP-A-0810258, WO 00/05300 or WO 00/05301.

The final composition thus obtained is then calendered, for example in the form of a sheet or of a slab, in particular for characterization in the laboratory, or else extruded (or co-extruded with another rubber composition) in the form of a semi-finished (or profiled) element of rubber that can be used, for example, as a tyre sidewall. These products can subsequently be used for the manufacture of tyres, according to techniques known to those skilled in the art.

The composition may be either in the uncured state (before crosslinking or vulcanization) or in the cured state (after crosslinking or vulcanization), may be a semi-finished product that can be used in a tyre.

The crosslinking (or curing), where appropriate the vulcanization, is carried out in a known manner at a temperature generally of between 130° C. and 200° C., for a sufficient time which may vary, for example, between 5 and 90 min, depending especially on the curing temperature, on the crosslinking system adopted and on the crosslinking kinetics of the composition in question.

### II-7 Tyre

A subject of the present invention is also a tyre comprising a rubber composition according to the invention.

Preferably, the composition according to the invention is present at least in a sidewall of the tyre according to the invention. Advantageously, this composition is present exclusively in the sidewalls of the tyre.

The tyre according to the invention may be intended to equip motor vehicles of passenger vehicle type, SUVs ("Sport Utility Vehicles"), or two-wheel vehicles (in particular motorcycles), or aircraft, or also industrial vehicles selected from vans, heavy-duty vehicles - that is to say, underground trains, buses, heavy road transport vehicles (lorries, tractors, trailers) or off-road vehicles, such as heavy agricultural vehicles or earthmoving equipment -, and others.

### III- PREFERRED EMBODIMENTS

In the light of the above, the preferred embodiments of the invention are described below:

A. Rubber composition based on at least:
n elastomer matrix containing at least one polyisoprene and at least one copolymer containing ethylene units and diene units,
a paraffin oil having a glass transition temperature, Tg, of less than -75° C.,
a reinforcing filler comprising carbon black, and
a crosslinking system,
in which the at least one polyisoprene and the at least one copolymer containing ethylene units and diene units represent more than 40% by weight of the elastomer matrix.

B. Rubber composition according to embodiment A, wherein the copolymer containing ethylene units and diene units is a copolymer of ethylene and of 1,3-diene.

C. Rubber composition according to embodiment B, wherein the ethylene units in the copolymer represent between 50 mol% and 95 mol% of the monomer units of the copolymer.

D. Rubber composition according to either one of embodiments B and C, wherein the 1,3-diene is 1,3-butadiene.

E. Rubber composition according to any one of embodiments B to D, wherein the copolymer contains units of formula (I) or units of formula (II) or else units of formula (I) and of formula (II):

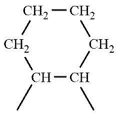

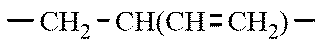

F. Rubber composition according to embodiment E, wherein the molar percentages of the units of formula (I) and of the units of formula (II) in the copolymer, respectively o and p, satisfy the following equation (eq. 1), preferentially satisfy the equation (eq. 2), o and p being calculated on the basis of all the monomer units of the copolymer:

$$0 < \text{o+p} \leq \text{25}$$

$$0 < \text{o+p} < 20$$

G. Rubber composition according to any one of the preceding embodiments, wherein the copolymer is a random copolymer.

H. Rubber composition according to any one of the preceding embodiments, wherein the copolymer has a number-average weight, Mn, that is within a range extending from 100 000 to 300 000 g/mol, preferably from 150 000 to 250 000 g/mol.

I. Rubber composition according to any one of the preceding embodiments, wherein the content of the copolymer containing ethylene units and diene units is less than 50 phr, preferably within a range extending from 15 to less than 45 phr, more preferably within a range extending from 20 to 40 phr.

J. Rubber composition according to any one of the preceding embodiments, wherein the polyisoprene comprises a content by weight of cis-1,4- bonds of at least 90% relative to the weight of the polyisoprene.

K. Rubber composition according to any of the preceding embodiments, wherein the polyisoprene is natural rubber, a synthetic polyisoprene or a mixture thereof, preferably natural rubber.

L. Rubber composition according to any one of the preceding embodiments, wherein the content of natural rubber is greater than 50 phr, preferably within a range extending from more than 55 phr to 80 phr, more preferably within a range extending from 60 to 80 pce.

M. Rubber composition according to any one of the preceding embodiments, wherein the at least one polyisoprene and the at least one copolymer containing ethylene units and diene units represent more than 70%, preferably more than 90%, by weight of the elastomer matrix.

N. Rubber composition according to any one of the preceding embodiments, wherein the at least one polyisoprene and the at least one copolymer containing ethylene units and diene units represent 100% by weight of the elastomer matrix.

O. Rubber composition according to any one of the preceding embodiments, wherein the paraffin oil has a Tg within a range extending from -78° C. to -150° C., preferably from -80° C. to -120° C.

P. Rubber composition according to any one of the preceding embodiments, wherein the paraffin oil has a degree of crystallinity of less than 20%, preferably less than 10%, more preferably less than 5%, measured by differential scanning calorimetry according to Standard ISO 11357-3-2013 at a temperature of 20° C.

Q. Rubber composition according to any one of the preceding embodiments, wherein the content of paraffin oil is within a range extending from 5 to 60 phr, preferably from 10 to 45 phr.

R. Rubber composition according to any one of the preceding embodiments, wherein the total content of plasticizer that is liquid at 20° C. is within a range extending from 5 to 60 phr, preferably from 10 to 45 phr.

S. Rubber composition according to any one of the preceding embodiments, wherein the composition does not comprise a plasticizer that is liquid at 20° C. other than paraffin oil, or contains less than 15 phr thereof, preferably less than 10 phr thereof.

T. Rubber composition according to any one of the preceding embodiments, wherein the composition does not comprise a plasticizing hydrocarbon resin.

U. Rubber composition according to any one of the preceding embodiments, wherein the reinforcing filler predominantly, preferably exclusively, comprises carbon black.

V. Rubber composition according to any one of the preceding embodiments, wherein the carbon black has a BET specific surface area within a range extending from 30 to 100 m²/g, preferably from 33 to 70 m²/g, more preferably from 35 to 50 m²/g.

W. Rubber composition according to any one of the preceding embodiments, wherein the carbon black content is within a range extending from 25 phr to 65 phr, preferably from 25 to 49 phr.

X. Rubber composition according to any one of the preceding embodiments, wherein the total content of reinforcing filler is within a range extending from 25 phr to 65 phr, preferably from 25 to 49 phr.

Y. Rubber composition according to any one of the preceding embodiments, wherein the crosslinking system is a vulcanization system.

Z. Tyre comprising a rubber composition defined in any one of embodiments A to Y.

AA. Tyre according to embodiment Z, wherein the rubber composition defined in any one of embodiments A to Y is present in at least one sidewall of the tyre.

### IV- EXAMPLES

### IV-1 Measurements and Tests Used

### Fatigue Test

The fatigue strength, expressed as number of cycles or in relative units (r.u.), is measured in a known manner on 12 test specimens subjected to repeated low-frequency tensile deformations up to an elongation of 75%, at 60° C., using a Monsanto (MFTR) machine until the test specimen breaks, according to Standards ASTM D4482-85 and ISO 6943.

The result is expressed in relative units (r.u.). A value greater than that of the control, arbitrarily set at 100, indicates an improved result, that is to say a better fatigue strength of the rubber samples.

### Dynamic Properties

The dynamic property tan(δ)max is measured on a viscosity analyzer (Metravib V A4000) according to Standard ASTM D5992-96. The response of a sample of vulcanized composition (cylindrical test specimen 4 mm thick and 400 mm² in cross section), subjected to sinusoidal loading in simple alternating shear stress at a frequency of 10 Hz, according to Standard ASTM D 1349 ― 99, at a temperature of 60° C., is recorded. A peak-to-peak strain amplitude sweep is carried out from 0.1 to 50% (outward cycle), then from 50% to 1% (return cycle). The result made use of is the loss factor (tan δ). For the return cycle, the maximum value of tan δ observed (tan(δ)max) is indicated.

The response of a sample of vulcanized composition subjected to a simple alternating sinusoidal shear stress during a temperature sweep, subjected to an imposed sinusoidal stress of 0.7 MPa and at a frequency of 10 Hz, at a temperature of 60° C., is also recorded, and the complex dynamic shear modulus (G*) at 60° C. is measured.

For greater readability, the results are shown in base 100 (percentage), the value 100 being assigned to the control. A result greater than 100 indicates an improvement in the performance in question. For "tan(δ)max", a result greater than 100 indicates a decrease in hysteresis and therefore better rolling resistance. For "G*", a result greater than 100 indicates a decrease in the complex dynamic shear modulus G*, which means that the stiffness is lower and therefore improved in the case of use in the sidewalls of tyres.

### IV-2 Preparation of the Compositions

In the examples which follow, the rubber compositions were produced as described in point II-6 above. In particular, the "non-productive" phase was carried out in a 0.4 litre mixer for 6 minutes, for a mean blade speed of 50 revolutions per minute, until a maximum dropping temperature of 160° C. was reached. The "productive" phase was carried out in an open mill at 23° C. for 10 minutes.

The crosslinking of the composition was carried out at a temperature of between 130° C. and 200° C., under pressure.

### IV-3 Rubber Tests

The object of the examples presented below is to compare the performance compromise between the fatigue resistance and the rolling resistance of a composition in accordance with the invention (C1) with respect to two control compositions (T1 and T2).

The compositions tested (in phr), as well as the results obtained, are presented in Table 1.

The performance results are expressed as percentage, base 100, with respect to the control composition T1 corresponding to a usual sidewall composition.

Table 1

| | T1 | T2 | C1 |
|---|---|---|---|
| NR⁽¹⁾ | 60 | 60 | 60 |
| EBR⁽²⁾ | 40 | 40 | 40 |
| N330⁽³⁾ | 29 | 29 | 29 |
| Liquid plasticizer 1⁽⁴⁾ | 20 | - | - |
| Liquid plasticizer 2⁽⁵⁾ | - | 20 | - |
| Liquid plasticizer 3⁽⁶⁾ | - | - | 20 |
| Antioxidant (7) | 3.0 | 3.0 | 3.0 |
| TMQ⁽⁸⁾ | 1.0 | 1.0 | 1.0 |
| ZnO | 3.0 | 3.0 | 3.0 |
| Stearic acid | 2.0 | 2.0 | 2.0 |
| Accelerator⁽⁹⁾ | 1.0 | 1.0 | 1.0 |
| Sulfur | 2.0 | 2.0 | 2.0 |
| Fatigue (MFTR) | 100 | 158 | 183 |
| G* at 60° C.; 0.7 MPa | 100 | 42 | 102 |

(1) Natural rubber
(2) Elastomer containing 79 mol% of ethylene units, 7 mol% of 1,2-cyclohexanediyl units, 8 mol% of 1,2 units of the butadiene part, and 6 mol% of 1,4 units of the butadiene part
(3) Carbon black of N330 grade according to Standard ASTM D-1765
(4) "Lubrirob Tod 1880" glycerol trioleate (sunflower oil comprising 85% by weight of oleic acid) from Novance (Tg = -90° C.)
(5) Trioctyl phosphate (tri-2-ethylhexyl phosphate) "Disflamoll TOF" from Lanxess (Tg = -110° C.)
(6) "Extensoil 51" paraffin oil from Repsol (Tg = -80° C.)
(7) N-(1,3-Dimethylbutyl)-N-phenyl-para-phenylenediamine, Santoflex 6-PPD from Flexsys
(8) "Pilnox TMQ" 2,2,4-trimethyl-1,2-dihydroquinoline from Nocil
(9) N-Cyclohexyl-2-benzothiazolesulfenamide, "Santocure CBS" from Flexsys

The results presented in Table 1 above show that the control composition T2 makes it possible to improve the fatigue resistance compared to the control composition T1, but to the detriment of the stiffness of the composition. On the other hand, the fatigue resistance of the compositions in accordance with the invention is greatly improved compared to the control compositions, this being without penalizing the stiffness of the composition. It was also observed (data not shown) that the hysteresis of the compositions in accordance with the invention was not penalized relative to the control composition T1.

1-15. (canceled)

16. A rubber composition based on at least:
an elastomer matrix containing at least one polyisoprene and at least one copolymer containing ethylene units and diene units;
a paraffin oil having a glass transition temperature, Tg, of less than -75° C.;
a reinforcing filler comprising carbon black; and
a crosslinking system,
wherein the at least one polyisoprene and the at least one copolymer containing ethylene units and diene units represent more than 40% by weight of the elastomer matrix.

17. The rubber composition according to claim 16, wherein the at least one copolymer containing ethylene units and diene units is a copolymer of ethylene and of 1,3-diene.

18. The rubber composition according to claim 17, wherein the ethylene units in the at least one copolymer represent between 50 mol% and 95 mol% of the monomer units of the copolymer.

19. The rubber composition according to claim 17, wherein the 1,3-diene is 1,3-butadiene.

20. The rubber composition according to claim 16, wherein the at least one copolymer is a random copolymer.

21. The rubber composition according to claim 16, wherein a content of the at least one copolymer containing ethylene units and diene units is less than 50 phr.

22. The rubber composition according to claim 16, wherein the at least one polyisoprene is natural rubber, a synthetic polyisoprene or a mixture thereof.

23. The rubber composition according to claim 16, wherein the at least one polyisoprene is natural rubber and a content of the natural rubber is greater than 50 phr.

24. The rubber composition according to claim 16, wherein the paraffin oil has a Tg within a range extending from -78° C. to -150° C.

25. The rubber composition according to claim 16, wherein the paraffin oil has a degree of crystallinity of less than 20%, measured by differential scanning calorimetry according to Standard ISO 11357-3-2013 at a temperature of 20° C.

26. The rubber composition according to claim 16, wherein a content of paraffin oil is within a range extending from 5 to 60 phr.

27. The rubber composition according to claim 16, wherein the reinforcing filler predominantly comprises carbon black.

28. The rubber composition according to claim 16, wherein a total content of reinforcing filler is within a range extending from 25 phr to 65 phr.

29. A tire comprising the rubber composition according to claim 16.

30. The tire according to claim 29, wherein the rubber composition is present in at least one sidewall of the tire.
